(19) United States
(12) Patent Application Publication
(10) Pub. No.: US 2006/0104626 A1
(43) Pub. Date: May 18, 2006

(54) Electronic camera

(76) Inventor: Takanobu Hisamitsu, Osaka (JP)

Correspondence Address: Gerald T. Bodner, Esq.;BODNER & O'ROURKE, LLP, Suite 108, 425 Broadhollow Road, Melville, NY, 11747, US

(21) Appl. No.: 11/268,279

(22) Filed: Nov. 4, 2005

(30) Foreign Application Priority Data
Nov. 17, 2004 (JP) 2004-332626

(51) Int. Cl. G03B 15/03

(52) U.S. Cl. 396/164; 396/182; 396/197

(57) ABSTRACT

An electronic camera includes a camera unit. In photographing an object continuously in a predetermined cycle by means of the camera unit, a main CPU controls a strobe control circuit to change combinations of transistors T1, T2 and T3 to be turned on/off in synchronization with the cycle of photography. As a result, the magnitudes of currents passing through a plurality of LEDs foming a strobe are changed, and thus the amount of light emitted from the strobe varies in synchronization with the cycle of photography.

### CROSS REFERENCE OF RELATED APPLICATION

The disclosure of Japanese Patent Application No. 2004-332626 is incorporated herein by reference.

### BACKGROUND OF THE INVENTION

1. Field of the Invention

The present invention relates to an electronic camera. More specifically, the present invention relates to an electronic camera that is applied to mobile communication terminals and uses LEDs as a strobe.

2. Description of the Prior Art

One example of this kind of conventional electronic camera is disclosed in Japanese Patent Laying-open No. 2003-101836. The electronic camera represented by this prior art comprises a strobe composed of a plurality of LEDs. In continuously photographing an object by means of this electronic camera, currents of the same magnitude are passed through the individual LEDs in synchronization with the cycle of photography. Thus, the strobe emits specific amount of light in each photographing operation.

However, if the optimum amount of light to be emitted by the strobe is unknown, it is difficult to determine the amount of light in this electronic camera. On this account, if bracket photography can be performed in advance by which photographs are continuously taken with a gradual change in the amount of light emitted by the strobe, it becomes easy to determine the optimum amount of light to be emitted by the strobe, based on the photographed images.

### SUMMARY OF THE INVENTION

Therefore, it is a primary object of the present invention to provide a novel electronic camera. It is another object of the present invention to provide an electronic camera that makes it possible to perform bracket photography.

The present invention of claim 1 is an electronic camera comprising: a photographer for photographing an object scene; a plurality of light-emitting devices; a driver for allowing at least one of the plurality of light-emitting devices to emit light when the photographer photographs the object scene; and a changer for, when the photographer continuously photographs the object scene in a predetermined cycle, changing in the predetermined cycle the light-emitting devices allowed to emit light by the driver.

In the present invention of claim 1, when the photographer continuously photographs the object scene in a predetermined cycle, the driver allows at least one of the plurality of light-emitting devices to emit light in each photographing operation. At that time, the light-emitting device is changed so as to emit light in the same cycle as the photographing cycle of the photographer. In this case, it is possible to perform bracket photography by which photographs are continuously taken with a sequential change in the amount of light emission from the light-emitting device, which makes it easy to determine the optimum amount of light to be emitted by the light-emitting device, based on the photographed images.

The present invention of claim 2 is an electronic camera according to claim 1, wherein the changer includes a descending-order selector for selecting the light-emitting device to emit light in order of decreasing amount of light emission. In this case, the descending-order selector selects the light-emitting device in order of decreasing amount of light emission and makes the selected light-emitting device emit light, which thus allows the electronic camera to perform bracket photography in order of decreasing amount of light emission.

The present invention of claim 3 is an electronic camera according to claim 1, wherein the changer includes an ascending-order selector for selecting the light-emitting device to emit light in order of increasing amount of light emission. In this case, the ascending-order selector selects the light-emitting device in order of increasing amount of light emission and makes the selected light-emitting device emit light, which thus allows the electronic camera to perform bracket photography in order of increasing amount of light emission.

The present invention of claim 4 is an electronic camera according to any one of claims 1 to 3, wherein the photographer includes an exposure time decider for deciding an exposure time according to illumination of the object scene and a gain adjuster for adjusting a gain of image signal corresponding to an optical image of the object scene. If the illumination of the object scene is high, the exposure time decider shortens the exposure time. On the other hand, if the illumination of the object scene is low, an image signal corresponding to an optical image of the object scene is decreased in magnitude, and thus the gain adjuster adjusts a gain of the image signal. This bracket photography makes it possible to not only determine the optimum amount of light emission from the light-emitting device but also change the exposure time and the gain according to the illumination of the object scene, thereby optimizing a condition for photography.

The present invention of claim 5 is an electronic camera according to any one of claims 1 to 4, wherein the light-emitting devices are LEDs and the amount of light emission is controlled according to currents passing through the LEDs by turning on or off transistors connected to the LEDs. In this case, the currents passing through the LEDs are controlled by turning on or off the transistors connected to the LEDs, making it easy to change the amount of light emission from the LEDs.

The present invention of claim 6 is an electronic camera according to any one of claims 1 to 5, wherein the cathodes of all the LEDs are connected to one another and the collectors of all the transistors are connected to one another. In this case, since currents of the same magnitude pass through all the LEDs, each of the LEDs emits the same amount of light.

The present invention of claim 7 is a mobile terminal comprising an electronic camera recited in any one of claims 1 to 6. In this case, the mobile terminal comprises an electronic camera allowing bracket photography, which thus makes it possible to photograph the object scene with the optimum amount of light emission.

According to the present invention, in continuously photographing the object scene in a predetermined cycle, the electronic camera makes it possible to change the amount of light emission from the light-emitting device sequentially in synchronization with the cycle of photography, thereby allowing bracket photography.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing one embodiment of the present invention;

FIG. 2 is a circuit diagram showing a structure of a strobe of the FIG. 1 embodiment;

FIG. 3 is a graph showing a relationship between the illumination of an object and AGC and a relationship between the illumination of the object and the shutter speed in the FIG. 1 embodiment;

FIG. 4 is a flowchart showing a part of operation of the FIG. 1 embodiment; and

FIG. 5 is a flowchart showing another part of operation of the FIG. 1 embodiment.

### DETAILED DESCRIPTION OF THE PREFERRED EMBODIMENTS

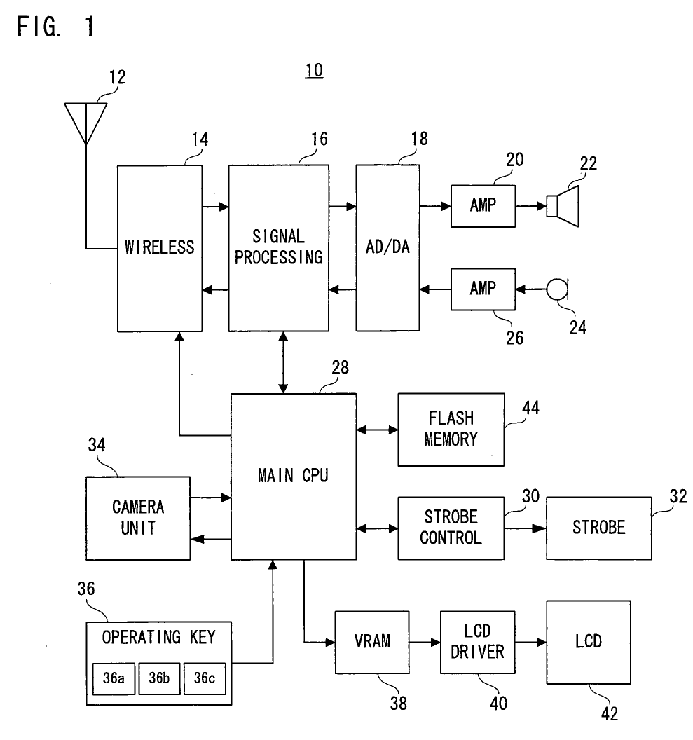

Referring to FIG. 1, a mobile communication terminal 10 of this embodiment includes an operating key 36. When a call-out operation is carried out by the operating key 36 for telephone communication, a main CPU 28 sends a call-out signal to a mobile communication terminal 10 of the other party, through a signal processing circuit 16, a wireless circuit 14 and an antenna 12. On the contrary, when the other party performs a call-in operation, the mobile communication terminal 10 becomes capable of a telephone conversation.

After a telephone conversation became available, when a sound is input to a microphone 24, the input sound is converted by the microphone 24 into a sound signal as an analog signal. The converted sound signal is amplified by an amplifier 26 and further converted by an AD/DA conversion circuit 18 into sound data as a digital signal. The converted sound data is encoded by the signal processing circuit 16, and further modulated by the wireless circuit 14. The modulated sound data generated by the wireless circuit 14 is transmitted from the antenna 12.

On the other hand, modulated sound data sent from the other party is received by the antenna 12, demodulated by the wireless circuit 14 and then decoded by the signal processing circuit 16. The sound data decoded by the signal processing circuit 16 is converted by the AD/DA conversion circuit 18 into a sound signal as an analog signal. The converted sound signal is output from the speaker 22 through the amplifier 20.

When a telephone communication end operation is performed by the operating key 36 in the middle of a telephone communication with the other party, the main CPU 28 controls the signal processing circuit 16 and the wireless circuit 14 to send a telephone communication end signal to the other party. After sending the telephone communication end signal, the main CPU 28 terminates the telephone communication process. In the case of receiving a telephone communication end signal from the other party, the main CPU 28 also terminates the telephone communication process.

When a camera function is activated by the operating key 36 in a state where no telephone communication is being held, a camera unit 34 and the main CPU 28 perform through-image output processes. Firstly, the camera unit 3 photographs the object and generates low-resolution moving image data corresponding to the photographed object. The main CPU 28 transfers the moving image data output from the camera unit 34 to a VRAM 38 for storage. The moving image data stored in the VRAM 38 is read out by an LCD driver 40. The read moving image data is provided to the LCD 42. As a result, a real-time moving image (through-image) of the object is displayed on the LCD 42.

When a release key 36a provided in the operating key 36 is operated, the camera unit 34 and the main CPU 28 perform image compression/storage processes. More specifically, the camera unit 34 generates high-resolution compressed still image data corresponding to the object at a point in time when the release key 36a is operated, and then outputs the generated compressed still image data to the main CPU 28. The main CPU 28 records on a flash memory 44 the compressed still image data provided by the camera unit 34. Accordingly, a data file containing the compressed still image data is created in the flash memory 44. Upon completion of recording the compressed image data, the through-image output process is started again.

In addition, the main CPU 28 controls the emission of light from the strobe 32 via a strobe control circuit 30. Since the strobe 32 includes a plurality of LEDs, the amount of light emission from the strobe 32 can be altered by changing the magnitude of currents passing through the LEDs by means of the strobe control circuit 30. When a descending key 36b or ascending key 36c provided in the operating key 36 is operated, the mobile communication terminal 10 performs bracket photography by which the object is continuously photographed with a sequential change in the amount of light emission from the strobe 32. To be more specific, when the descending key 36b is operated, the main CPU 28 instructs the strobe control circuit 30 to make the strobe 32 emit light while changing the amount of light emission in decreasing order, and at the same time, instructs the camera unit 34 to photograph the object continuously. On the other hand, when the ascending key 36c is operated, the main CPU 28 instructs the strobe control circuit 30 to make the strobe 32 emit light while changing the amount of light emission in increasing order, and at the same time, instructs the camera unit 34 to photograph the object continuously.

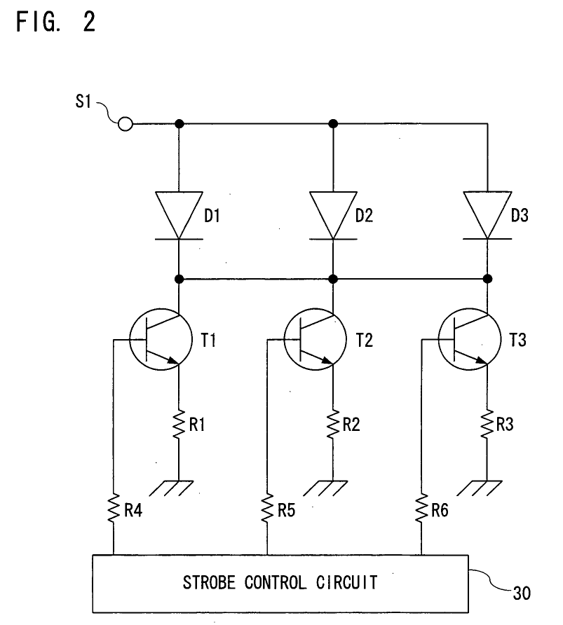

Referring to FIG. 2, a description is given as to a structure of the strobe 32 including three LEDs, D1, D2 and D3. The anodes of the LEDs D1, D2 and D3 are each connected to a +5-V power supply (not shown) via a terminal S1. The cathodes of the LEDs D1, D2 and D3 are connected to one another, and collectors of NPN transistors T1, T2 and T3 are connected to one another. Besides, the connected cathodes and the connected collectors are further connected to one another. Bases of the transistors T1, T2 and T3 are connected to the strobe control circuit 30 via resistors R4, R5 and R6, respectively. Emitters of the transistors T1, T2 and T3 are grounded via resistors R1, R2 and R3, respectively.

Next, the operation of the strobe 32 is described below. It is assumed here that the LEDs D1, D2 and D3 are under the same standard. Firstly, when a voltage is applied to the base of the transistor T1, only the transistor T1 is turned on. Accordingly, a current passes from the power supply through the LEDs D1, D2 and D3 to the resistor R1. At that time, the magnitudes of currents passing through the LEDs D1, D2 and D3 are one third each of that of the current passing through the resistor R1. Since the LEDs D1, D2 and D3 are all under the same standard and also are the same in magnitude of currents passing through them, they emit the same amount of light.

Also, when voltage is applied to the bases of the transistors T1 and T2, the transistors T1 and T2 are turned on. Accordingly, a current passes from the power supply through the LEDs D1, D2 and D3 to the resistors R1 and R2 connected in parallel to each other. In this case, the magnitudes of currents passing through the LEDs D1, D2 and D3 are one third each of the sum of magnitudes of currents passing through the resistors R1 and R2, and thus the magnitudes of the currents passing through the LEDs D1, D2 and D3 are higher as compared with the case in which only the transistor T1 is turned on. With this, the brightness of the LEDs D1, D2 and D3 also becomes higher.

Moreover, when a voltage is applied to each of the bases of the transistors T1, T2 and T3, the transistors T1, T2 and T3 are turned on. Thus, a current passes from the power supply through the LEDs D1, D2 and D3 to the resistors R1, R2 and R3 connected in parallel to each other. In this case, the magnitudes of the currents passing through the LEDs D1, D2 and D3 are one third each of the sum of magnitudes of currents passing through the resistors R1, R2 and R3, and thus the magnitudes of currents passing through the LEDs D1, D2 and D3 become much higher as compared with the case in which the transistors T1 and T2 are turned on. According to that, the brightness of the LEDs D1, D2 and D3 also becomes much higher.

In this manner, changing the combinations of transistors to be turned on leads to an alteration in the combination of the resistors determining the magnitudes of currents. Accordingly, this changes the magnitudes of currents passing through the LEDs D1, D2 and D3, which brings about a change in the amount of light emission from the strobe 32. That is, by selecting appropriately the resistance values of the resistors R1, R2 and R3 and changing sequentially the patterns of combinations of transistors to be turned on, it is possible to make the strobe 32 emit light in order of decreasing amount of light or in order of increasing amount of light. Therefore, bracket photography can be performed through the use of the light emitted by the strobe 32.

With the strobe 32, there are seven (7) combinations of transistors to be turned on. More specifically, it is possible to turn on all the transistors T1, T2 and T3, turn on any two of the transistors T1, T2 and T3, or turn on any one of the transistors T1, T2 and T3. By changing the combinations, the magnitudes of currents passing through the LEDs D1, D2 and D3 can be adjusted in seven levels. According to that, the amount of light emission from the strobe 32 can be also changed in seven levels.

It is assumed here that a relationship among the resistance values of the three resistors R1, R2 and R3 is R1>R2>R3, and that the resistance values are 30Ω, 20Ω and 10Ω, respectively. In this case, the magnitudes of currents passing through the LEDs D1, D2 and D3 becomes lower in the following order of the combinations of transistors to be turned on: a combination of the transistors T1, T2 and T3, a combination of the transistors T2 and T3, a combination of the transistors T1 and T3, a combination of the transistors T1 and T2, only the transistor T3, only the transistor T2, and only the transistor T1. The lower the magnitude of the currents is, the less the amount of light emitted from the LEDs D1, D2 and D3 becomes, which leads to a decrease in the amount of light emitted from the strobe 32.

As stated above, the seven combinations of the transistors T1, T2 and T3 to be turned on are available, from the pattern 1 with largest amount of light in which all the transistors T1, T2 and T3 are turned on to the pattern 7 with smallest amount of light in which only the transistor T1 is turned on.

Therefore, when the descending key 36b is operated by the operator, the main CPU 28 instructs the strobe control circuit 30 to control the on/off states of the transistors T1, T2 and T3 and also instructs the camera unit 34 to photograph the object in order to photograph the object with a sequential switchover from the pattern 1 to the pattern 7. Consequently, it becomes possible to continuously photograph the object with a sequential decrease in the amount of light emission from the strobe 32.

On the other hand, when the ascending key 36c is operated by the operator, the main CPU 28 instructs the strobe control circuit 30 to control the on/off states of the transistors T1, T2 and T3 and also instructs the camera unit 34 to photograph the object in order to photograph the object with a sequential switchover from the pattern 7 to the pattern 1. Consequently, it becomes possible to continuously photograph the object with a sequential increase in the amount of light emission from the strobe 32. In this manner, after the bracket photography, the optimum amount of light emission from the strobe 32 can be easily determined on the basis of the photographed images.

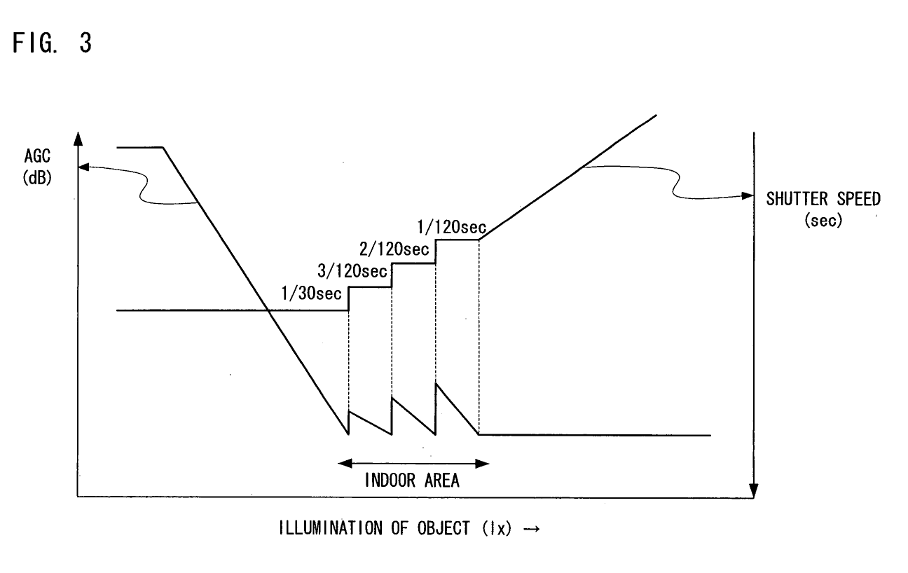

In addition to the determination of the optimum amount of light emitted from the strobe 32 through the bracket photography, the optimum condition for photography can be determined by further controlling the gain of an AGC (Auto Gain Control) circuit included in the camera unit 34 and the shutter speed according to the illumination of the object. Referring to FIG. 3, a description is given as to a relationship among the illumination of the object and the gain of the AGC circuit and the shutter speed. It is assumed here that the frame rate of an image output from the camera unit 34 is 30 fps and the frequency of the alternating-current power supply is 60 Hz.

In the case of the frame rate of 30 fps, it is impossible to lower the shutter speed below 1/30 second. Thus, when the illumination of the object is much lowered, an image signal output from the image sensor included in the camera unit 34 is decreased in magnitude, resulting in a dark image. In this case, as the illumination of the object becomes lower, it is necessary to increase the magnitude of the image signal by changing the gain of the AGC circuit.

Next, with consideration given to indoor photography, the shutter speed is changed stepwise according to the illumination of the object, from 1/30 second to 1/120 second, by multiples of 1/120 second that is equivalent to the half cycle of the frequency of the alternating-current power supply. This makes it possible to cancel a flicker of fluorescent light. At that time, since the shutter speed changes stepwise, the magnitude of the image signal also changes stepwise. Thus, in order to correct the changed magnitude of the image signal, the gain of the AGC circuit is changed in a sawtooth waveform pattern according to changes in the shutter speed.

Besides, in the case where a frequency of the alternating-current power supply is 50 Hz, the flicker of fluorescent light can be canceled by changing the shutter speed from 1/25 second to 1/100 second by multiples of 1/100 second.

Moreover, when the illumination of the object becomes high, the shutter speed is raised to higher than 1/120 second, which disables flicker cancellation. Thus, the shutter speed is made higher as the illumination of the object is increased. At that time, since the magnitude of the image signal output from the image sensor is sufficiently high, the gain of the AGC circuit is set at 0 dB.

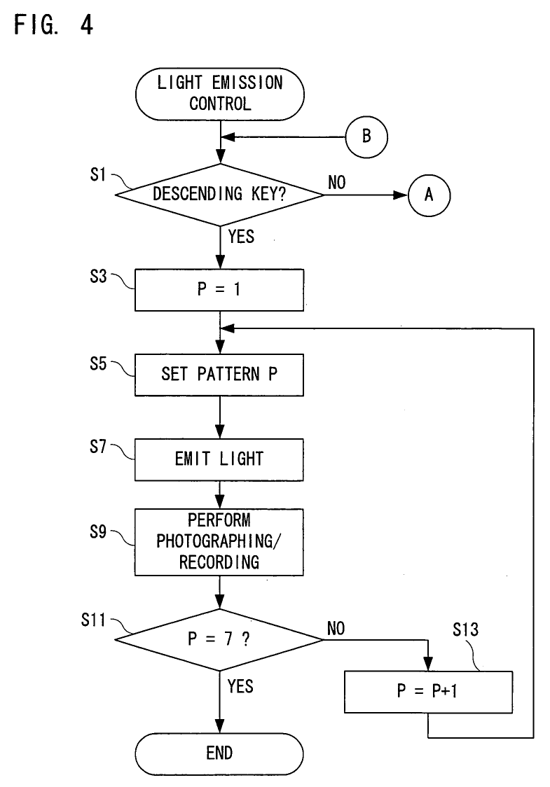

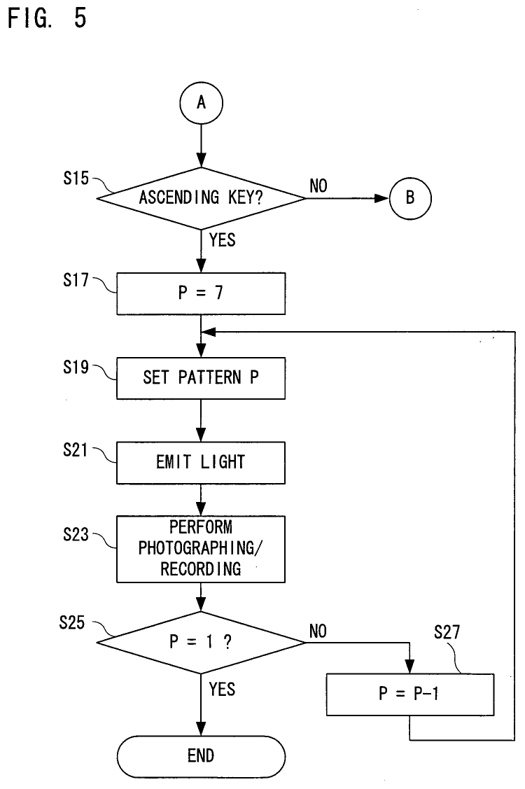

When the camera function is activated, the main CPU 28 performs processes according to the flowchart shown in FIG. 4 and FIG. 5 to control light emission from the strobe 32 required for bracket photography. Firstly, in a step S1, it is determined whether or not the descending key 36b is pressed to make the strobe 32 emit light in order of decreasing amount of light. If the result of determination is YES, “1” is assigned to a variable P for the pattern indicative of a combination of the transistors to be turned on, among the transistors T1, T2 and T3. That is, the variable P is set so that all the transistors T1, T2 and T3 are turned on.

In a step S5, the strobe control circuit 30 is controlled to set the on/off states of the transistors T1, T2 and T3, based on the pattern corresponding to the variable P. In a step S7, currents are passed through the LEDs D1, D2 and D3 for light emission. In a step S9, the camera unit 34 is controlled to photograph the object, and an image of the photographed object is recorded on the flash memory 44.

In a step S1, it is determined whether the variable P is “7” or not, that is, whether the variable P is set in such a manner as to turn on only the transistor T1. If the result of determination is NO, the variable P is incremented in a step S13, the on/off states of the transistors T1, T2 and T3 are set in such a manner that the amount of light emitted from the strobe 32 is decreased, and then the process is returned to the step S5. If YES is determined, the process exits.

In the meanwhile, if NO is determined in the step S1, the process moves to a step S15 to determine whether the ascending key 36c is pressed to make the strobe 32 emit light in order of increasing light amount. If the result of determination is YES, the variable P for the pattern is set at “7” in a step S17. That is, the variable P is set so that only the transistor T1 is turned on. In the step S19, the strobe circuit 30 is controlled to set the on/off states of the transistors T1, T2 and T3 based on the pattern corresponding to the variable P. In a step S21, currents are passed through the LEDs D1, D2 and D3 for light emission. In a step S23, the camera unit 34 is controlled to photograph the object and an image of the photographed object is recorded on the flash memory 44.

In a step S25, it is determined whether the variable P is “1” or not, that is, whether the variable P is set so as to turn on all the transistors T1, T2 and T3. If the determination result is NO, in a step S27, the variable P is decremented to set the on/off states of the transistors T1, T2 and T3 in such a manner that the amount of light emitted from the strobe 32 is increased, and then the process is returned to the step S19. If YES is determined, the process exists.

As understood from the above description, in photographing the object continuously in a predetermined cycle by means of the camera unit 34, the strobe control circuit 30 is controlled so as to turn on/off the transistors T1, T2 and T3 in synchronization with the cycle of the photography and make emit light at least one of the plurality of LEDs D1, D2 and D3 forming the strobe 32. Thus, this enables bracket photography by which continuous photography is performed with a sequential change in the amount of light emission from the strobe 32, making it easy to determine the optimum amount of light emission from the strobe 32 based on the photographed images.

Besides, in FIG. 2, the cathodes of the LEDs D1, D2 and D3 are connected to one another and the collectors of the transistors T1, T2 and T3 are connected to one another. Alternatively, the cathodes may not be connected to one another, the collectors may not be connected to one another, and the cathodes may be connected to the collectors in a one-to-one correspondence. In this case, a current is passed through only the one(s) among the LEDs D1, D2 and D3, which are connected to the transistor(s) to be turned on. Additionally, the current passed through the LED is determined by the resistance value of the resistor connected to the LED. Therefore, since currents varied in magnitude are passed through the individual LEDs, the LEDs emit different amount of light.

Moreover, although this embodiment is described with the use of the mobile communication terminal 10, the present invention is also applicable to any kind of electronic devices with camera function, more preferably, mobile electronic devices.

Although the present invention has been described and illustrated in detail, it is clearly understood that the same is by way of illustration and example only and is not to be taken by way of limitation, the spirit and scope of the present invention being limited only by the terms of the appended claims.

1. An electronic camera comprising:
a photographer for photographing an object scene;
a plurality of light-emitting devices;
a driver for allowing at least one of said plurality of light-emitting devices to emit light when said photographer photographs said object scene; and
a changer for, when said photographer continuously photographs said object scene in a predetermined cycle, changing in said predetermined cycle said light-emitting devices allowed to emit light by said driver.

2. An electronic camera according to claim 1, wherein said changer includes a descending-order selector for selecting the light-emitting device to emit light in order of decreasing amount of light emission.

3. An electronic camera according to claim 1, wherein said changer includes an ascending-order selector for selecting the light-emitting device to emit light in order of increasing amount of light emission.

4. An electronic camera according to claim 1, wherein said photographer includes an exposure time decider for deciding an exposure time according to illumination of said object scene and a gain adjuster for adjusting a gain of image signal corresponding to an optical image of said object scene.

5. An electronic camera according to claim 1, wherein said light-emitting devices are LEDs and the amount of light emission is controlled according to currents passing through said LEDs by turning on or off transistors connected to said LEDs.

6. An electronic camera according to claim 1, wherein the cathodes of all said LEDs are connected to one another and the collectors of all said transistors are connected to one another.

7. A mobile terminal comprising an electronic camera recited in claim 1.

8. A photographing method by means of an electronic camera having a plurality of light-emitting devices, comprising steps of:
a photographing step of photographing an object scene;
a light emitting step of allowing at least one of said plurality of light-emitting devices to emit light when said object scene is photographed in said photographing step; and
a changing step of, when said object scene is continuously photographed in a predetermined cycle in said photographing step, changing in said predetermined cycle said light-emitting devices allowed to emit light in said light emitting step.

9. An electronic camera according to claim 2, wherein said photographer includes an exposure time decider for deciding an exposure time according to illumination of said object scene and a gain adjuster for adjusting a gain of image signal corresponding to an optical image of said object scene.

10. An electronic camera according to claim 3, wherein said photographer includes an exposure time decider for deciding an exposure time according to illumination of said object scene and a gain adjuster for adjusting a gain of image signal corresponding to an optical image of said object scene.

11. An electronic camera according to claim 2, wherein said light-emitting devices are LEDs and the amount of light emission is controlled according to currents passing through said LEDs by turning on or off transistors connected to said LEDs.

12. An electronic camera according to claim 3, wherein said light-emitting devices are LEDs and the amount of light emission is controlled according to currents passing through said LEDs by turning on or off transistors connected to said LEDs.

13. An electronic camera according to claim 4, wherein said light-emitting devices are LEDs and the amount of light emission is controlled according to currents passing through said LEDs by turning on or off transistors connected to said LEDs.

14. An electronic camera according to claim 2, wherein the cathodes of all said LEDs are connected to one another and the collectors of all said transistors are connected to one another.

15. An electronic camera according to claim 3, wherein the cathodes of all said LEDs are connected to one another and the collectors of all said transistors are connected to one another.

16. An electronic camera according to claim 4, wherein the cathodes of all said LEDs are connected to one another and the collectors of all said transistors are connected to one another.

17. An electronic camera according to claim 5, wherein the cathodes of all said LEDs are connected to one another and the collectors of all said transistors are connected to one another.

18. A mobile terminal comprising an electronic camera recited in claim 2.

19. A mobile terminal comprising an electronic camera recited in claim 3.

20. A mobile terminal comprising an electronic camera recited in claim 4.
